(19) United States
(12) Patent Application Publication
(10) Pub. No.: US 2026/0141661 A1
(43) Pub. Date: May 21, 2026

(54) VOICEOVER AUDIO DATA GENERATION USING 3D OBJECT MODELS AND GENERAL LANGUAGE MODELS

(71) Applicant: Chateauz Inc., Newark, DE (US)

(72) Inventors: Melissa Sui-Ping Lim, San Diego, CA (US); David Scott Gibson, Weston, CT (US)

(21) Appl. No.: 19/394,511

(22) Filed: Nov. 19, 2025

Related U.S. Application Data
(60) Provisional application No. 63/722,899, filed on Nov. 20, 2024.

(51) Int. Cl. G06T 19/20; G10L 13/04

(52) U.S. Cl. CPC G06T 19/20; G10L 13/04

(57) ABSTRACT

An online system automates the generation and presentation of video content for physical objects. The system stores object data and 3D models for users, including models of objects for sale. Users can generate and manage visual markers on 3D models to highlight specific features. The system generates videos depicting the physical objects using the stored models and object data, and produces synchronized audio voiceovers describing the objects' features. Script generation prompts are created based on object data and input to a generative language model to generate scripts for the voiceover. The system generates voiceover audio data using text-to-speech or generative AI models and combines the audio with the video. The resulting video and audio data are transmitted to a client device for user presentation and interaction. The system provides an integrated workflow for creating, editing, and presenting detailed, object-specific video content with automated narration.

### CROSS-REFERENCE TO RELATED APPLICATIONS

This application claims the benefit of U.S. Provisional Application No. 63/722,899, entitled “Video and Script Generation for 3D Virtual Objects” and filed Nov. 20, 2025, the contents of which are incorporated by reference.

### BACKGROUND

Online systems may present content associated with physical objects in the real world. These systems often maintain data about those objects, such as descriptive text, images, or 3D models. However, making information about those objects accessible and understandable to users remains a significant technical challenge. Some systems may provide interactive 3D models that allow users to view additional information about the objects, but these systems frequently offer inelegant or limited user experiences. Delivering more sophisticated and engaging experiences typically requires substantial manual labor and technical expertise. Conventional approaches to content generation for physical objects are often time-consuming, resource-intensive, and may lack consistency or scalability.

### SUMMARY

An online system automates the generation of video explanations of physical objects by using a generative language model to generate a script of a voiceover and adding audio data for that voiceover to a video depicting the object.

For example, the online system may access object data describing a physical object. The object data may include a text description of the physical object and a 3D virtual model of the physical object. The virtual model may include visual markers added by a user to highlight features of the physical object.

The online system generates a script generation prompt based on the accessed object data. A script generation prompt is a prompt for a generative language model to generate a script for a voiceover describing the physical object. For example, the script may include text to be read for the voiceover or may include guidelines that explain what should be said in the voiceover at a higher level. The script generation prompt includes the text description of the physical object and possibly images or video of the object from the object data.

The online system inputs the script generation prompt to a generative language model to generate the script, and uses the script to generate voiceover audio data for a video depicting the physical object. The video may be one received by the online system from a user or may be generated by the online system. For example, to generate the video, the online system may generate rendering parameters for rendering a video of the physical object from the 3D virtual model of the object. The online system may use the rendering parameters to render a video of the physical object based on the 3D virtual model.

The online system generates voiceover audio data for the video. The voiceover audio data is audio data that contains a voiceover describing the physical object. The online system may generate the audio data by applying a text-to-speech system to the generated script or by prompting a generative model to generate speech based on guidelines contained in the script. The online system may modify the video data to include the voiceover audio data and transmits the voiceover audio data and the video data to a user for presentation.

The online system reduces the need for extensive manual scripting, video editing, and voiceover production by leveraging existing descriptions of physical objects and generative machine-learning models. For example, the use of generative language models and automated rendering techniques enables the system to produce detailed and engaging video content with synchronized voiceover narration directly from the available object data. This approach streamlines the creation of sophisticated user experiences, reduces the labor and technical expertise required, and allows for scalable, rapid generation of interactive content that accurately conveys information about physical objects.

### BRIEF DESCRIPTION OF THE DRAWINGS

FIG. 1 illustrates an example system environment for an online system, in accordance with some embodiments.

FIG. 2 is a flowchart illustrating a method for generating voiceover audio data for a rendered video of an object's virtual model, in accordance with some embodiments.

FIG. 3 illustrates an example 3D virtual model of a physical object with visual markers, in accordance with some embodiments.

FIG. 4 illustrates an example data flow for generating voiceover audio data for an object video, in accordance with some embodiments.

FIG. 5 illustrates an example data flow for generating voiceover audio data based on a script, in accordance with some embodiments.

FIG. 6 illustrates an example user interface for displaying a video depicting a physical object along with a voiceover, in accordance with some embodiments.

### DETAILED DESCRIPTION

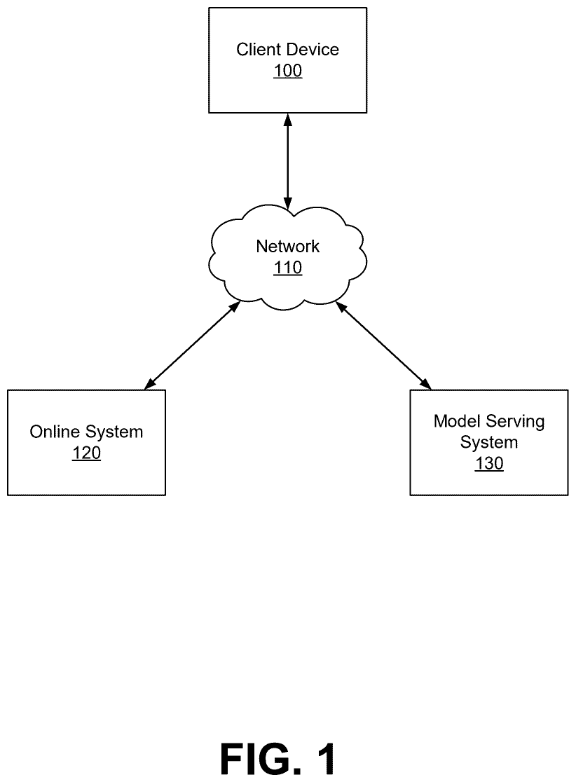

FIG. 1 illustrates an example system environment for an online system 120, in accordance with some embodiments. The system environment illustrated in FIG. 1 includes a client device 100, a network 110, an online system 120, and a model serving system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The user client device 100 is a client device through which a user may interact with the online system 120. The client device 100 can be a personal or mobile computing device, such as a smartphone, a tablet, a laptop computer, or desktop computer. In some embodiments, the user client device 100 executes a client application that uses an application programming interface (API) to communicate with the online system 120.

The user client device 100, the online system 120, and the model serving system 130 can communicate with each other via the network 110. The network 110 is a collection of computing devices that communicate via wired or wireless connections. The network 110 may include one or more local area networks (LANs) or one or more wide area networks (WANs). The network 110, as referred to herein, is an inclusive term that may refer to any or all of the standard layers used to describe a physical or virtual network, such as the physical layer, the data link layer, the network layer, the transport layer, the session layer, the presentation layer, and the application layer. The network 110 may include physical media for communicating data from one computing device to another computing device, such as multiprotocol label switching (MPLS) lines, fiber optic cables, cellular connections (e.g., 3G, 4G, or 5G spectra), or satellites. The network 110 also may use networking protocols, such as TCP/IP, HTTP, SSH, SMS, or FTP, to transmit data between computing devices. In some embodiments, the network 110 may include Bluetooth or near-field communication (NFC) technologies or protocols for local communications between computing devices. The network 110 may transmit encrypted or unencrypted data.

The model serving system 130 receives requests from the online system 120 to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 130 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 130 receives a request including input data (e.g., text data, audio data, image data, or video data) and encodes the input data into a set of input tokens. The model serving system 130 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 120 or one or more entities different from the online system 120. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the task for the model serving system 130 is based on knowledge of the online system 120 that is fed to the machine-learned model of the model serving system 130, rather than relying on general knowledge encoded in the model weights of the model. Thus, one objective may be to perform various types of queries on the external data in order to perform any task that the machine-learned model of the model serving system 130 could perform. For example, the task may be to perform question-answering, text summarization, text generation, and the like based on information contained in an external dataset.

Thus, in one embodiment, the online system 120 is connected to an interface system. The interface system receives external data from the online system 120 and builds a structured index over the external data using, for example, another machine-learned language model or heuristics. The interface system receives one or more queries from the online system 120 on the external data. The interface system constructs one or more prompts for input to the model serving system 130. A prompt may include the query of the user and context obtained from the structured index of the external data. In one instance, the context in the prompt includes portions of the structured indices as contextual information for the query. The interface system obtains one or more responses from the model serving system and synthesizes a response to the query on the external data. While the online system 120 can generate a prompt using the external data as context, often times, the amount of information in the external data exceeds prompt size limitations configured by the machine-learned language model. The interface system can resolve prompt size limitations by generating a structured index of the data and offers data connectors to external data sources.

The example system environment in FIG. 1 illustrates an environment where the model serving system 130 is managed by a separate entity from the online system 120. However, in alternative embodiments, the model serving system 130 (or the interface system) is part of the online system 120.

The online system 120 provides a platform for storing and managing object data associated with physical objects for users, including 3D virtual models of objects such as those offered for sale by a user. The system supports the storage and retrieval of 3D models and related object data, enabling users to maintain comprehensive digital representations of their physical items. The online system also can generate videos that depict the physical objects based on the stored models and object data. The online system also can generate audio voiceovers for those videos, producing synchronized narration that describes the features and attributes of the objects. Additionally, the online system enables users to generate and manage visual markers on 3D models, allowing for the annotation and highlighting of specific features within the digital representation of each object.

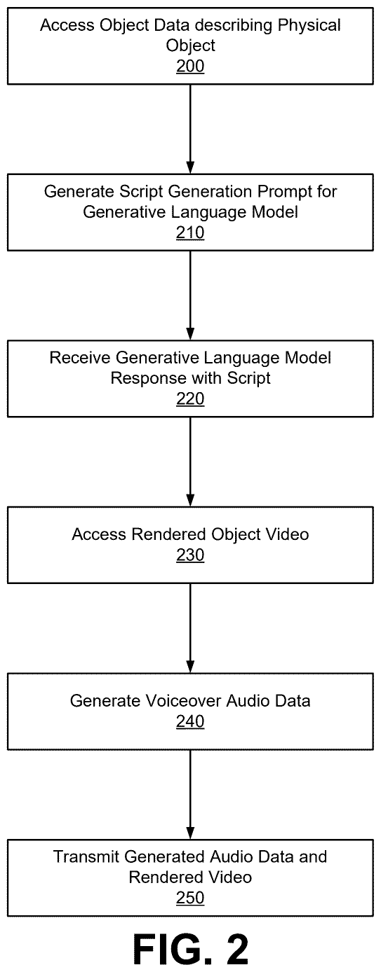

FIG. 2 is a flowchart illustrating a method for generating voiceover audio data for a rendered video of an object's virtual model, in accordance with some embodiments. Alternative embodiments may include more, fewer, or different steps from those illustrated in FIG. 2, and the steps may be performed in a different order from that illustrated in FIG. 2. These steps may be performed by an online system (e.g., online system 120). Additionally, each of these steps may be performed automatically by the online system without human intervention.

The online system accesses 200 object data for a physical object. Object data is data that describes a physical object. For example, the object data may include object text, which is a text description of the object. This object text may include object information such as name, type, price, dimensions, and other characteristics of the object. The text also may include script attribute information, which indicates how the object should be described in a script. For example, the script attribute information may specify what customers love about the object, common uses, complaints, and words to avoid. The object text is generally a natural language description, however the object text may include structured text data. For example, the object text may include JSON formatted text that describes features of the object. The object data may include other kinds of data, such as images of the object, video of the object, or audio of a person describing the object.

The online system may receive object data from a client device associated with a user. For example, a user may upload or generate the object data through a user interface of a client application or web browser. The online system also may receive object data from a database. For example, the online system may receive locator information for object data specifying a location of the object data and may use the locator information to retrieve the object data from the database.

In some embodiments, the object data includes a 3D model of the object. The 3D model data describes how to depict the object in a virtual environment. For example, the 3D model data may include a mesh for the object structure, textures, shaders, lighting information, animation data, and material properties. The 3D model data of the object may include visual markers of features of the object. Visual markers are markers that may be displayed with the object when the object is rendered. The visual markers have corresponding data structures within the 3D model that correspond to features of the object. For example, a 3D model of a coffee maker may include visual markers corresponding to the water reservoir, the filter basket, and the control panel. The features may correspond to physical structures of the object, such as material, components, color, shape, size, or surface finish. The features also could be functional. For example, the features could correspond to heating elements, moving parts, user interface controls, or safety mechanisms. The visual markers include a corresponding location on the 3D model of the object. For example, the visual markers may include a 3D location relative to the 3D model origin point. The visual markers also include text data. The text data describes the feature corresponding to the visual marker and may include a title for the marker.

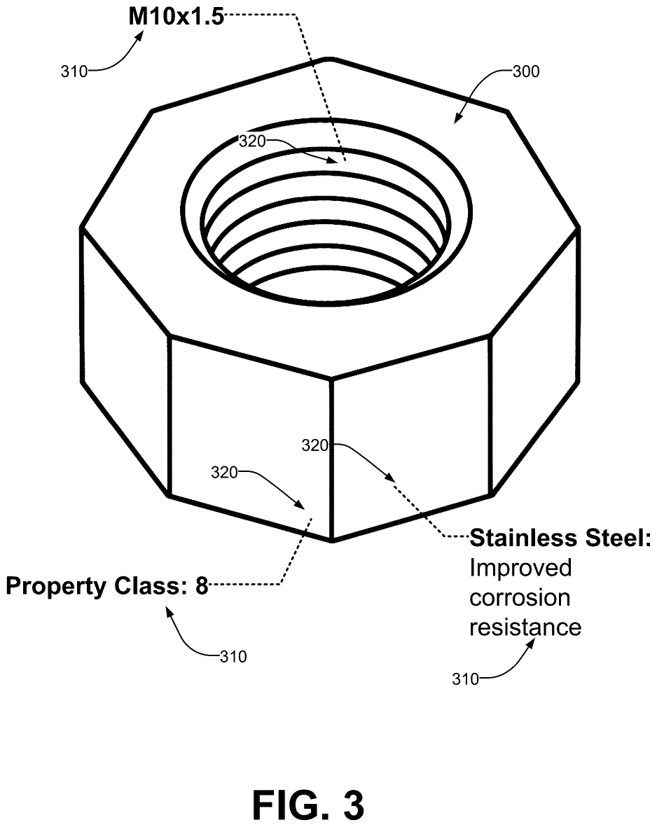

FIG. 3 illustrates an example 3D virtual model 300 of a physical object with visual markers 310, in accordance with some embodiments. Each of the visual markers has a corresponding location 320 on the 3D virtual model and includes text descriptions of features of the physical object.

The online system may enable a user to generate visual markers through a workflow provided by the online system. For example, the online system may access 3D model data for the object and render an image or video of the object based on the 3D model data. The online system may render the object within a virtual environment, such as a store or a room. The virtual environment may be selected by the user or may be an environment designed to enhance a user's ability to add visual markers. The online system may select the virtual environment based on object data for the physical object. For example, the online system may select the environment based on the size of the object, materials of the object, or textures applied to the object model.

The online system transmits the rendering of the object to a client device for display to the user through a user interface. The online system may generate new renderings of the object as the user interacts with the rendering. For example, the user may be able to drag on the image to view the object from different orientations.

The user interface may receive user interactions that indicate locations on the 3D model to add visual markers. For example, the online system may enable the user to interact with a location on the rendering and translate that interaction at a 2D location on the rendering into a 3D location on the model. The user can also provide text for each marker with the provided locations to generate visual markers. The online system modifies the 3D model of the object to add the visual markers to the 3D model.

The online system generates 210 a script generation prompt for a generative language model based on the object data to generate an object video script. The object video script is a script for a video of the object. For example, the object video script may be a script for a product-demo video. The object video script describes speech for a voiceover to be played along with the video. For example, the script may specify speech by a voiceover or narrator. The script may contain literal text for what should be spoken during the voiceover. Alternatively, the script may contain high-level guidelines for the voiceover or a description of what text should be generated for the voiceover. For example, the script may contain a description of which features of the object to describe, the style or tone of the speech, the intended audience, or the level of technical detail to include. In some embodiments, the script describes scenes to be shown of the object. For example, the script may describe camera angles, transitions between scenes, specific actions to be performed with the object, close-up shots of particular features, or background settings for each scene. The script may specify the order in which features are presented, the duration of each scene, and any visual effects to be applied.

The script generation prompt includes instructions for a generative language model to generate a script based on the object text. For example, the instructions may describe what should be generated for the script, how the script should be formatted, the style or tone of the script, the level of detail to include, and the intended audience. The instructions may specify whether the script should include literal speech, high-level guidelines, or scene descriptions. The instructions may also specify requirements for the structure of the script, such as the use of headings, scene breakdowns, or time codes. The instructions may include script parameters that may be set by the user. For example, the parameters may include the length of the script, the number of scenes, an environment to be displayed, the language or dialect to be used, the pacing of the narration, or the inclusion of specific features or attributes of the object.

The online system transmits the script generation prompt to the generative language model and receives 220 a response from the generative language model with the script. The online system extracts the script from the generative language model's response. The user can make edits to the text or script at any time during the workflow. For example, the online system may present the script to the user in a user interface and the user can make edits to the script. Similarly, the online system may present the received script in the user interface next to text from the object data and may allow the user to edit the text in the object data. The online system uses these edits to reprompt the generative language model.

The online system accesses 230 an object video for the object. In some embodiments, the online system generates a video for the object. For example, the online system may generate the video by rendering the video based on the 3D model of the object. The online system may use rendering parameters for rendering the video. For example, the online system may use camera rendering parameters, such as camera position, camera angle, field of view, depth of field, and camera movement path. Similarly, the online system may use output parameters, such as video resolution, frame rate, aspect ratio, and encoding format.

The online system may receive the rendering parameters for the object video with the object data. Alternatively, the online system may generate rendering parameters for the video. For example, the online system may use a machine-learning model that is trained to output rendering parameters for rendering a video of a physical object based on received object data. The machine-learning model may be trained based on labeled training data that includes example object data and labels of parameters to output for that object data. Similarly, the online system may use a generative language model to generate the parameters. For example, the online system may prompt a generative language model to generate parameters for rendering based on object data. Furthermore, the online system may use a generative video model to generate video of the physical object.

In some embodiments, the online system uses the script to generate the video. For example, the script may specify scenes to generate or what portions of the object should be displayed in the rendering, and the online system generates the video based on those descriptions in the script. In some embodiments, the online system may use the script to generate rendering parameters.

Rather than generating the video, the online system may receive the object video from a user. In these embodiments, the object video is used to generate the script. For example, the object video may be included with the script generation prompt and the instruction in the prompt may instruct the generative language model to generate a script based on the video.

The online system generates 240 voiceover audio data for the video. The voiceover audio data is audio data for a voiceover to play along with the video. The voiceover in the audio data is a recorded or synthesized narration that may be synchronized with the video. The voiceover describes the physical object. For example, the voiceover may describe features corresponding to visual markers in the object data. In some embodiments, the voiceover audio data includes music audio data.

The online system generates the voiceover audio data based on the script. In embodiments where the script contains actual speech to be spoken in the audio data, the online system may use a text-to-speech system to generate the audio data. The text-to-speech system may be part of the online system or separate from the online system. In embodiments where the script contains guidelines for generating audio data, the online system may generate the full text for the speech based on the script. For example, the online system may prompt a generative language model to generate the full text for the speech based on the script. The online system also may use the video to generate the text for the speech. For example, the online system may prompt a multi-modal generative language model with the video to generate text for the speech. The online system uses the full text for the speech to generate audio data (e.g., using a text-to-speech system).

In some embodiments, the online system generates voiceover audio data based on the object video. For example, the online system may generate the voiceover audio data as part of generating the object video. The online system may identify a set of key markers and frames in the selected video to generate audio data. The online system may include these key markers and frames in a prompt to a multi-modal generative language model to generate the speech text for the audio. The online system may use a generative AI model to generate audio data for a voiceover narration. Inputs to the generative AI model may include the generated script, object data for the object, and the identified key markers and frames. In some embodiments, the whole video may be input to the generative AI model.

The online system transmits 250 the generated audio data along with the object video to a client device for presentation to the user. The object video and audio data are presented to the user through an object video user interface. The user interface includes elements for viewing or editing the video, which may be with or without audio. The user interface also may include elements for listening to or interacting with the voiceover audio, which may be separate from the video. The user interface may further include elements for viewing or editing the script or object data used to generate the script.

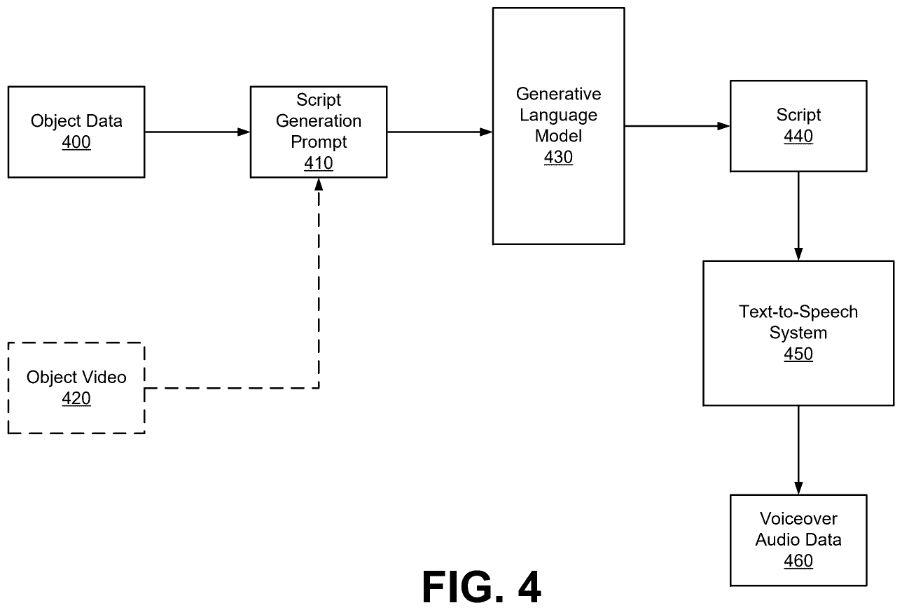

FIG. 4 illustrates an example data flow for generating voiceover audio data for an object video, in accordance with some embodiments. An online system uses object data 400 to generate a script generation prompt 410 to generate a script for an object video 420. The online system may also use the object video 420 to generate the script generation prompt 410. The online system inputs the script generation prompt into a generative language model 430 to generate a script 440, and uses a text-to-speech system 450 to generate the voiceover audio data 460. The text-to-speech system 450 may include a generative model that generates audio data based on a prompt.

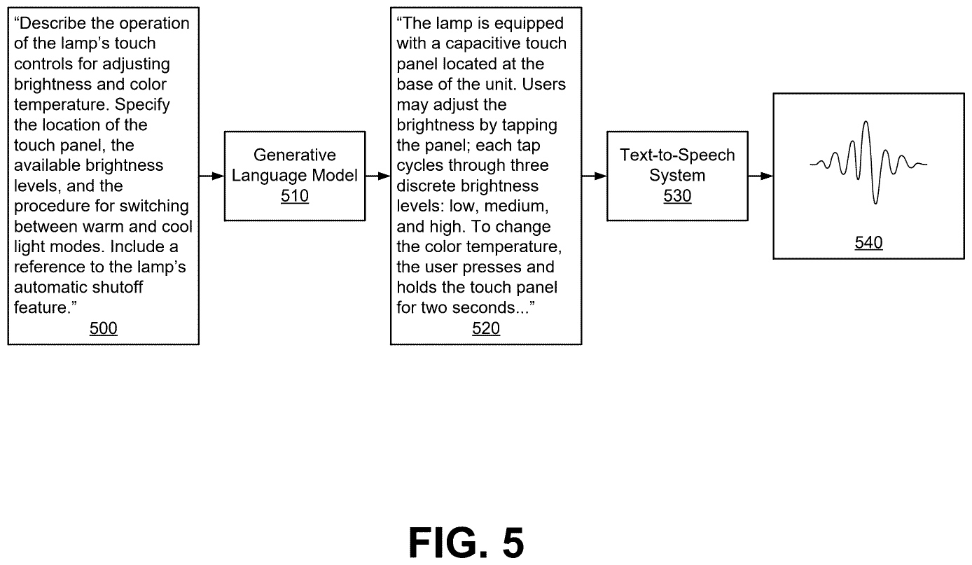

FIG. 5 illustrates an example data flow for generating voiceover audio data based on a script, in accordance with some embodiments. In the illustrated embodiment, the generated script 500 contains guidelines for generating text to be spoken in a voiceover. The online system inputs the generated script into a generative language model 510 to generate the full text 520 for the voiceover. The online system inputs the full text into a text-to-speech system 530 to generate the audio data 540 for the voiceover.

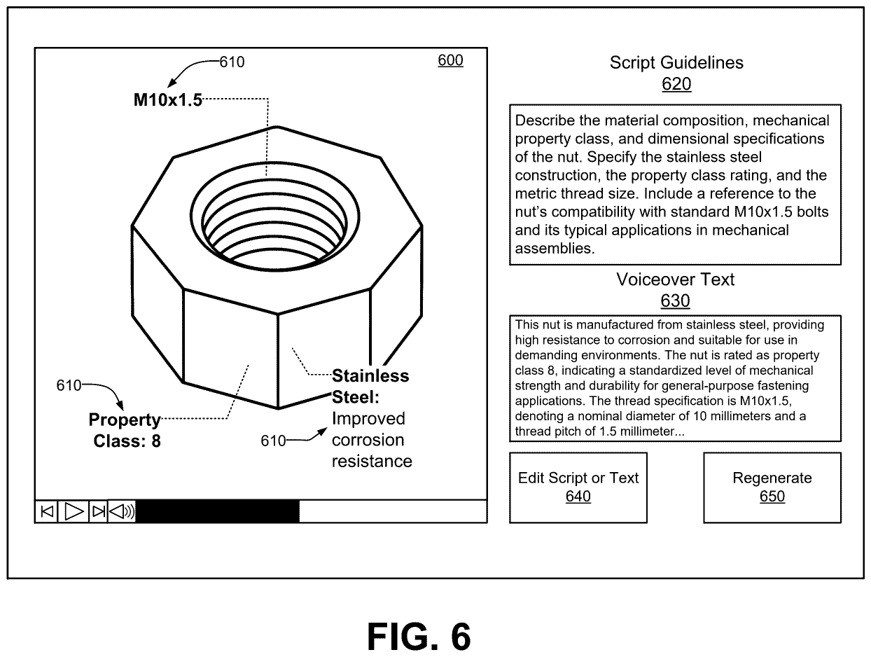

FIG. 6 illustrates an example user interface for displaying a video depicting a physical object along with a voiceover, in accordance with some embodiments. The user interface displays a rendered video 600 of the object based on the 3D virtual model of the object. The video 600 may depict visual markers 610 stored in the 3D virtual model. The user interface also displays a script 620 that was generated for generating voiceover audio data. In the illustrated embodiment, the script 620 describes a set of guidelines for generating the voiceover, and the user interface also displays voiceover text 630 that was generated for generating the voiceover audio data. Furthermore, the user interface includes a user interface element 640 for editing the script 620 or the voiceover text 630 and a user interface element 650 for regenerating the voiceover text or voiceover audio data based on edits the user may have made.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
accessing, by an online system, object data describing a physical object, wherein the object data comprises object text data comprising a text description of the physical object and a three-dimensional virtual model of the physical object;
generating a script generation prompt based on the object data, wherein the script generation prompt is a prompt for a generative language model to generate a script for a voiceover describing the physical object, wherein the script generation prompt includes the object text data and instructions to the generative language model to generate the script based on the object text data;
transmitting the script generation prompt to the generative language model;
receiving a response from the generative language model, wherein the response comprises the script for the physical object;
accessing an object video associated with the physical object, wherein the object video comprises a video rendering of the three-dimensional virtual model of the physical object;
generating voiceover audio data for the object video based on the script and the accessed object video, wherein the voiceover audio data comprises audio data of speech describing the physical object; and
transmitting the voiceover audio data and the object video to a client device associated with a user of the online system, wherein transmitting the voiceover audio data and the object video causes the client device to provide the voiceover audio data and the object video to the user through a user interface.

2. The method of claim 1, wherein the object data comprises at least one of image data depicting the physical object, video data depicting the object, and audio data describing the object.

3. The method of claim 1, wherein the text description of the physical object comprises a description of attributes of the physical object for inclusion in the script.

4. The method of claim 1, wherein the three-dimensional virtual model of the physical object comprises a set of visual markers, wherein each of the set of visual markers corresponds to a location on the three-dimensional virtual model and comprises a text description for a feature of the physical object.

5. The method of claim 4, further comprising generating the set of visual markers by:
generating an initial rendering of the three-dimensional virtual model of the physical object;
transmitting the initial rendering to the client device associated with the user of the online system for display to the user through a user interface, wherein the user interface enables the user to add the set of visual markers to the three-dimensional virtual model; and
modifying the three-dimensional virtual model to include the set of visual markers.

6. The method of claim 4, wherein the video rendering depicts the set of visual markers.

7. The method of claim 1, further comprising: generating the object video based on the object data for the physical object, wherein generating the object video comprises:
generating the video rendering of the object based on rendering parameters.

8. The method of claim 7, wherein the rendering parameters include camera parameters describing a virtual camera position for generating the video rendering.

9. The method of claim 7, further comprising:
applying a machine-learning model to the object data associated with the physical object to generate the rendering parameters.

10. The method of claim 1, wherein the script comprises voiceover text to be read for a voiceover, and wherein generating the voiceover audio data comprises applying a text-to-speech system to the text.

11. The method of claim 1, wherein the script comprises guidelines for generating voiceover text to be read for a voiceover, and wherein generating the voiceover audio data comprises prompting a generative language model to generate text based on the guidelines and the object data.

12. A non-transitory computer-readable medium storing computer-executable instructions that, when executed, cause a computing system to perform operations comprising:
accessing, by an online system, object data describing a physical object, wherein the object data comprises object text data comprising a text description of the physical object and a three-dimensional virtual model of the physical object;
generating a script generation prompt based on the object data, wherein the script generation prompt is a prompt for a generative language model to generate a script for a voiceover describing the physical object, wherein the script generation prompt includes the object text data and instructions to the generative language model to generate the script based on the object text data;
transmitting the script generation prompt to the generative language model;
receiving a response from the generative language model, wherein the response comprises the script for the physical object;
accessing an object video associated with the physical object, wherein the object video comprises a video rendering of the three-dimensional virtual model of the physical object;
generating voiceover audio data for the object video based on the script and the accessed object video, wherein the voiceover audio data comprises audio data of speech describing the physical object; and
transmitting the voiceover audio data and the object video to a client device associated with a user of the online system, wherein transmitting the voiceover audio data and the object video causes the client device to provide the voiceover audio data and the object video to the user through a user interface.

13. The computer-readable medium of claim 12, wherein the object data comprises at least one of image data depicting the physical object, video data depicting the object, and audio data describing the object.

14. The computer-readable medium of claim 12, wherein the text description of the physical object comprises a description of attributes of the physical object for inclusion in the script.

15. The computer-readable medium of claim 12, wherein the three-dimensional virtual model of the physical object comprises a set of visual markers, wherein each of the set of visual markers corresponds to a location on the three-dimensional virtual model and comprises a text description for a feature of the physical object.

16. The computer-readable medium of claim 15, further comprising generating the set of visual markers by:
generating an initial rendering of the three-dimensional virtual model of the physical object;
transmitting the initial rendering to the client device associated with the user of the online system for display to the user through a user interface, wherein the user interface enables the user to add the set of visual markers to the three-dimensional virtual model; and
modifying the three-dimensional virtual model to include the set of visual markers.

17. The computer-readable medium of claim 15, wherein the video rendering depicts the set of visual markers.

18. The computer-readable medium of claim 12, further comprising: generating the object video based on the object data for the physical object, wherein generating the object video comprises:
generating the video rendering of the object based on rendering parameters.

19. The computer-readable medium of claim 18, wherein the rendering parameters include camera parameters describing a virtual camera position for generating the video rendering.

20. The computer-readable medium of claim 18, further comprising:
applying a machine-learning model to the object data associated with the physical object to generate the rendering parameters.
